(19) United States
(12) Patent Application Publication
(10) Pub. No.: US 2007/0198631 A1
(43) Pub. Date: Aug. 23, 2007

(54) Method and system for data exchange between servers and mobile devices

(76) Inventor: Joerg Uhlmann, Mannheim (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/344,154

(22) Filed: Feb. 1, 2006

(51) Int. Cl. G06F 15/16

(52) U.S. Cl. 709/203

(57) ABSTRACT

A method for communicating information of tasks includes originating the tasks, planning tours by grouping the tasks into tours, and transferring information of the tours to mobile devices. A method for exchanging information of tasks includes originating the tasks, grouping the tasks into tours at a tour engine, transferring information of the tours to mobile devices, receiving updates upon performance of the tasks at the mobile devices, transferring the updates to the tour engine, and settling the performed tasks. A system for arranging tasks to be performed by field workers includes one or more servers for originating the tasks. A tour engine groups the tasks into tours. A method for generating a software application includes receiving configuration data, creating tables in a database; creating interfaces between a tour engine and other parts of a mobile system; and generating codes to be executed by the tour engine.

### TECHNICAL FIELD

The present invention relates to methods for exchanging data between backend systems and mobile devices and, more particularly, to methods for exchanging data between backend systems and mobile devices by grouping information for each mobile device.

### DESCRIPTION OF THE RELATED ART

Most companies either use employees to deliver products or packages to customers or they use delivery companies such as Federal Express (FedEx), United Parcel Service (UPS), etc. Sometimes the service personnel of a company need to service the products upon customers' requests. When a customer makes a request for an order or service, for example, the company may receive the request at the company's server, and generate an instruction to be followed by field workers such as the delivery or service personnel. In many conventional systems, a field worker carries a mobile device such as a personal digital assistant (PDA), and the instruction is transmitted to the delivery or service personnel when the handheld device is connected to the server through wired or wireless connections. After the field worker performs the requested service or delivery, information indicating the completion of the request is entered into the handheld device, and transmitted to the company's server. The server reconciles that information with the outstanding request in the request database and closes, or “settles,” open requests that have been fulfilled.

An exemplary mobile system 100 is shown in FIG. 1. In FIG. 1, system 100 includes a server 102 and a mobile device 104. Server 102 may be a server a company uses for daily businesses. Server 102 includes a database 108 for storing business data including customer data, supply information, purchase information, stock, etc., in complex database structures. Mobile device 104 may be, for example, a PDA. A field worker operates mobile device 104,for making deliveries or providing services to customers. The deliveries or services often only require a small subset of the data stored in server 102, and a mobile infrastructure (MI) server 106 connected between mobile device 104 and server 102 extracts such subset from database 108 in server 102 and makes the subset available to mobile device 104.

Again referring to FIG. 1, server 102 also includes several application modules collectively labeled with reference numeral 110, a middleware server 112 for communicating between application modules 110 and MI server 106, and an interface module 114. Application modules 110 may include an application module for receiving and processing orders, an application module for generating delivery instructions, an application module for generating invoices, financial applications for updating financial accounts, etc. Database 108 stores comprehensive company data in complex data structures. For example, a complete record of a customer order in database 108 may contain all possible information of a customer order such as the name and address of the customer, the order date, the name of the employee taking the order, the product identifier, the weight and size of the ordered product, the product stocking information (such as whether the product is in stock or on backorder), the original price, the discount applied, the shipping method, whether partial delivery is acceptable, the expected delivery date, the warranty, etc. However, a delivery personnel generally does not need to know all such information. For example, the delivery personnel does not need to know the name of the employee taking the order, the weight and size of the ordered product, the shipping method, whether partial delivery is acceptable, the expected delivery date, etc. In other words, mobile device 104 operated by a field worker only requires a certain subset of all information stored on server 102.

Thus, MI server 106 includes a middleware 116 for receiving such subset of information and stores it in simplified tables in a replica database (RDB) 118. MI server 106 also includes an interface module 120 for communicating between server 102 and middleware 116. Mobile device 104 may include an interface module 122, a database 124, and application modules 126. When mobile device 104 is connected to MI server 106, mobile device 104 receives only the subset of information stored in the simplified tables and stores the same in database 124. Because the subset of information is less and easier to deal with than the complex complete records originally stored in database 108 in server 102, the volume of data transferred to mobile device 104 is reduced and the traffic between mobile device 104 and server 102 is also reduced.

Although only one mobile device 104 is shown, more mobile devices 104 may connect to server 102 through MI server 106. MI server 106 may serve a plurality of mobile devices 104 by receiving the information required by all such mobile devices 104 and storing the information in RDB 118. Each mobile device 104 may connect to MI server 106 to receive the information it needs.

FIG. 2 is a flow chart illustrating the process of handling customer orders as an example of how system 100 operates. First, a customer places an order through telephone or the internet (Step 202). After server 102 receives the customer order, application modules 110 process the customer order (Step 204) and stores the customer order in database 108 (Step 206). At the same time, application modules 110 send a message containing the customer order to middleware server 112 (Step 208). Middleware server 112 places a remote function call (RFC) to MI server 106 (Step 210) and triggers the transfer of data to RDB 118 (Step 212). When mobile device 104 connects to MI server 106, a synchronization occurs between RDB 118 and database 124 such that customer orders to be handled by, or other business data needed by, the field worker operating mobile device 104 are received at mobile device 104 and stored in database 124 (Step 214). The transfer of the data between MI server 106 and mobile device 104 may be through HTTP transfer. The delivery personnel operating mobile device 104 may then make the deliveries according to the data stored in mobile device 104 and update the data as the deliveries are made through application modules 126 (Step 216). After the orders have been delivered, mobile device 104 reconnects to MI server 106 to synchronize the updated data of the customer orders with RDB 118 in MI server 106 (Step 218). MI server 106 transmits the updates of the customer orders back to server 102 through middleware 116 (Step 220). Application modules 110 update database 108 to settle delivered orders (Step 222).

There are several problems associated with using a conventional system such as system 100 as shown in FIG. 1. First, because mobile device 104 and server 102 use different data formats, data must be converted from one format into the other and back again. Particularly, data stored in more complex structures must be converted into simpler structures to be handled by the mobile devices. After the mobile devices update the data stored therein, such data are still stored in the simpler data structures and must be converted to conform with the more complex structures to be stored in the company server. Such conversions increase burden on the system. Also, when a server such as server 102 handles the needs of a great number of mobile devices, the network traffic is heavy and a jam may occur. The problem of network traffic jam is the worst for big companies such as FedEx, which may have many field workers trying to connect to the server at the same time, such as in the early morning of every work day.

Moreover, the MI server (such as MI server 106) generally serves many mobile devices. Thus, the task of determining which part of the information stored in the RDB (such as RDB 118) to each mobile device requires complex configuration and administration.

### SUMMARY

Consistent with embodiments of the present invention, a method communicates information of tasks to be performed by field workers between one or more servers and a plurality of mobile devices operated by the field workers. The one or more servers include a tour engine and a plurality of application modules. The method includes originating the tasks to be performed by the field workers at the one or more servers, planning tours at the tour engine for the field workers by grouping the ones of the tasks to be performed by each of the field workers into a tour, and transferring information of each of the tours to a corresponding one of the mobile devices.

Also consistent with embodiments of the present invention, a method exchanges information of tasks to be performed by field workers between one or more servers and a plurality of mobile devices operated by the field workers. The servers include a tour engine. The method includes originating the tasks to be performed by the field workers at the one or more servers, planning tours for the field workers at the tour engine by grouping the ones of the tasks to be performed by each of the field workers into a tour, transferring information of each of the tours from the server to a corresponding one of the mobile devices, receiving updates upon performance of the tasks in each tour at the corresponding mobile device, transferring the updates from the mobile devices to the server, and settling the tasks in the tours which have been performed.

Also consistent with embodiments of the present invention, a system arranges tasks to be performed by field workers includes one or more servers for originating the tasks. The servers include a database for storing information of the tasks and a tour engine for grouping the tasks to be performed by each of the field workers into a tour.

In another aspect, a method generates a software application for a tour engine in a mobile system. The mobile system includes one or more servers and a plurality of mobile devices. The servers include the tour engine, a plurality of application modules, and a database. The tour engine gathers customer request information for planning tours for customer requests. The method includes receiving configuration data for generating the software application, the configuration data including at least one of whether the mobile system includes a tour planning tool connected to the tour engine for planning tours, whether the mobile system includes intermediate servers between the server and the mobile devices for assisting in planning and updating the tours, and whether a particular sequence is required for updating the application modules; creating tables accessed by the tour engine in the database; creating interfaces between the tour engine and the application modules; and generating codes to be executed by the application modules and the tour engine for gathering the customer request information and for planning the tours.

Additional features and advantages of the invention appear in the following description and will be obvious from the description, or may be learned by practicing the invention. The foregoing background and summary are not intended to be comprehensive, but instead serve to help one skilled in the art understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, explain the principles of the invention. In the drawings:

FIG. 1 shows an example of a conventional mobile system;

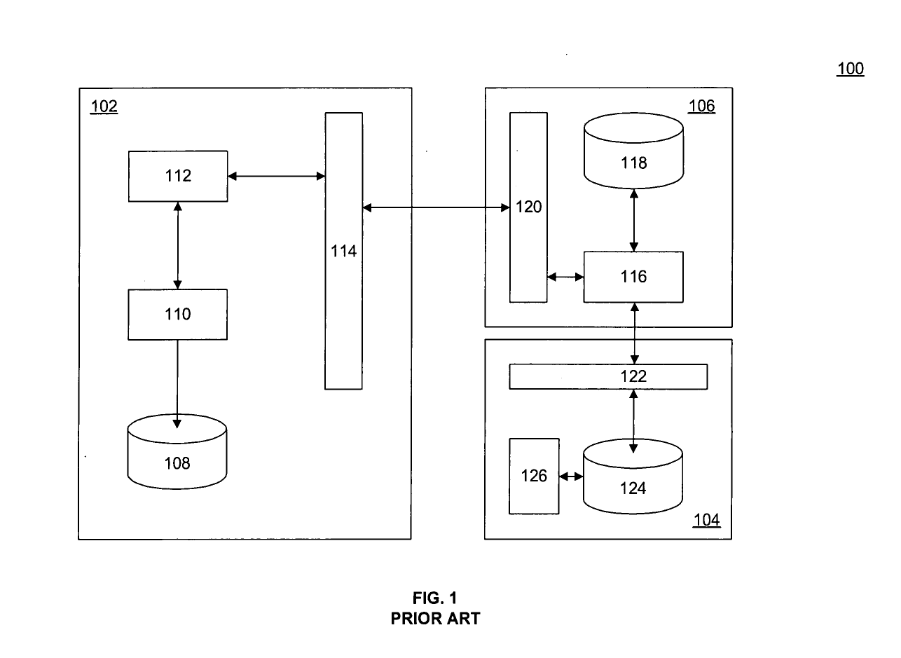

FIG. 2 is a flow chart illustrating the process of handling customer orders as an example of the operation of the conventional system shown in FIG. 1;

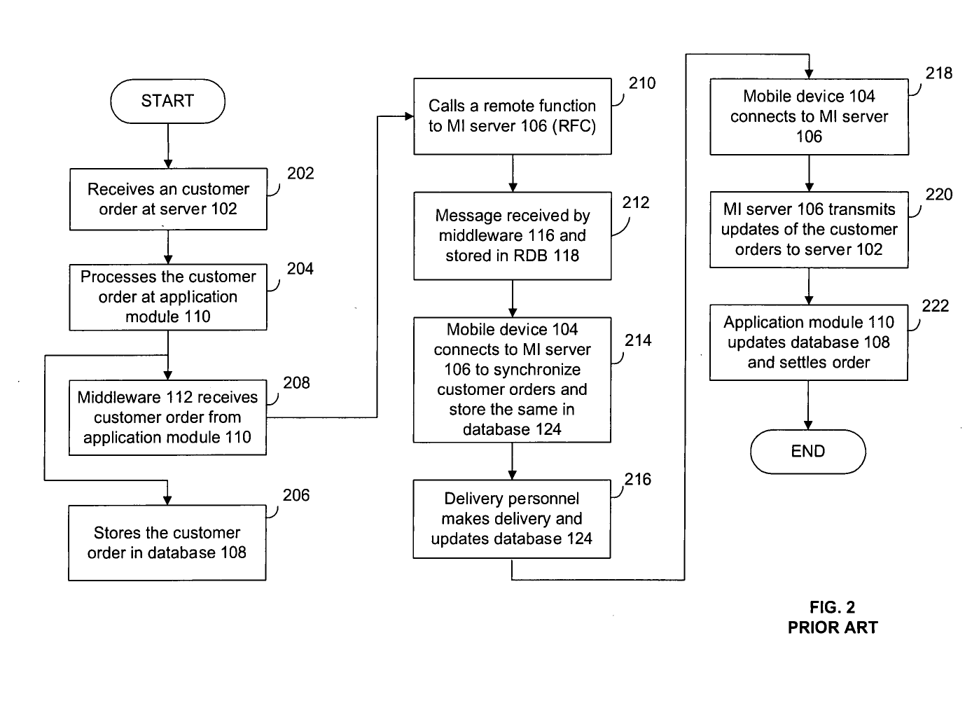

FIG. 3A shows a mobile system consistent with a first embodiment of the present invention;

FIG. 3B shows a mobile system consistent with a second embodiment of the present invention;

FIG. 4 is a flowchart showing a method consistent with embodiments of the present invention;

FIG. 5 shows a mobile system consistent with a third embodiment of the present invention; and

FIG. 6 shows a method for generating a method for generating a software application for implementing the systems and method shown in FIGS. 3A-3B, 4, and 5.

### DETAILED DESCRIPTION OF THE EMBODIMENTS

The following description refers to the accompanying drawings, in which, in the absence of a contrary representation, the same numbers in different drawings represent similar elements. The following implementations do not represent all implementations consistent with the claimed invention, but are merely examples. Other implementations, and modifications of the described implementations, may also fall within the scope of present invention.

Methods and systems consistent with the present invention may be used for exchanging data between backend servers, or application servers, and mobile devices operated by field workers such as delivery personnel or service personnel. There may be one or more tasks for each field worker on a working day and such tasks are originated at the backend servers and communicated to the field workers at their respective mobile devices. In certain exemplary embodiments, a server groups data of the tasks to be performed by each field worker into a tour and transfers the tour information to the mobile device operated by the corresponding field worker. Methods and systems consistent with the present invention also allow for the use of intermediate servers between the backend servers and the mobile devices, thereby reducing the work load on the backend servers. In the following descriptions, customer request for service or customer order of a product are used as examples of tasks to be performed by a field worker.

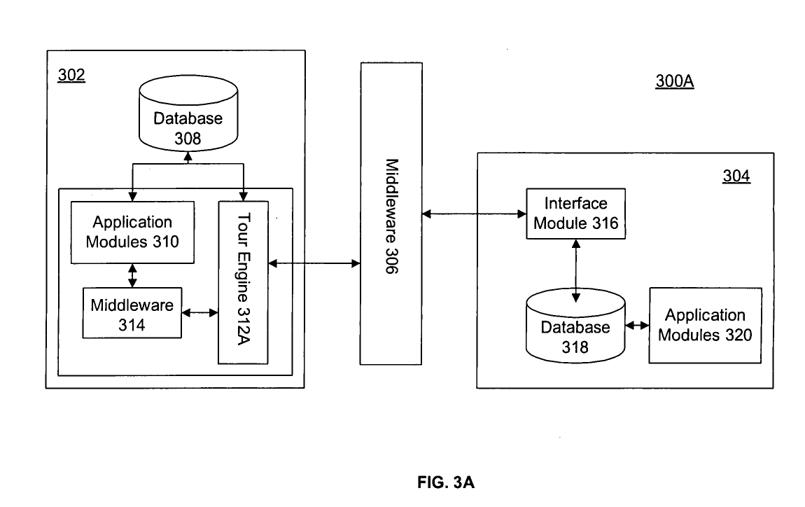

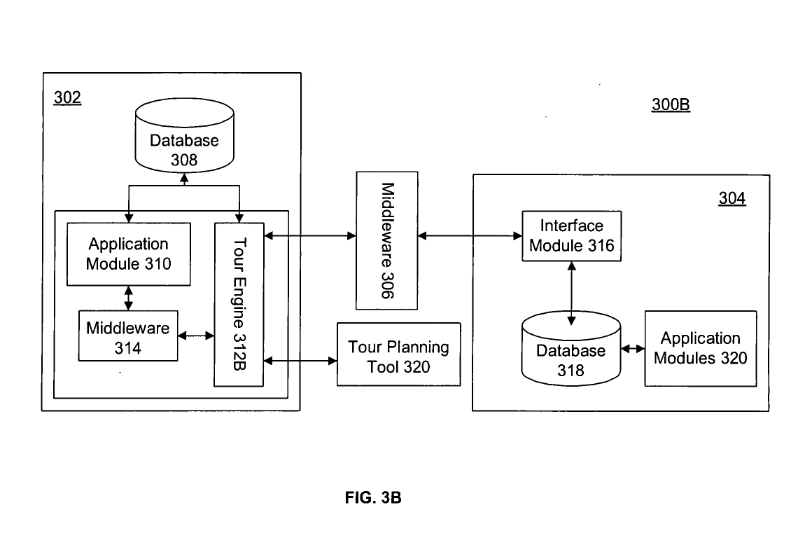

A mobile system 300A consistent with a first embodiment of the present invention is shown in FIG. 3A. System 300A may include one or more servers for handling different tasks. For example, a mobile system consistent with embodiments of the present invention may include one server for handling deliveries, a second server for handling customer orders, and a third server for handling financial accounts. However, for convenience of illustration, it is assumed that system 300A only includes one server. Particularly, FIG. 3A shows that system 300A includes a server 302 for receiving requests from customers, storing the customer requests, and planning tours for field workers, etc. The field workers use mobile devices 304 (only one of which is shown) to connect to server 302 to receive the tour information. Mobile devices 304 may connect to server 302 directly or, as shown in FIG. 3A, through a middleware 306, via wired or wireless connections. Although FIG. 3A shows middleware 306 to be external to server 302, it is to be understood that middleware 306 can also be a part of server 302. Further, although not illustrated in FIG. 3A, mobile devices 304 may also connect to server 302 through an MI server.

Server 302 includes a database 308 for storing comprehensive company data and a plurality of application modules collectively labeled with reference numeral 310. Each of application modules 310 performs a certain function and may control a respective portion of database 308 for data process and storage. For example, application modules 310 may include an application module for receiving and processing orders and updating the orders with any adjustments after the order has been processed, an application module for generating delivery instructions, an application module for generating invoices, financial applications for updating financial accounts, etc. If system 300A includes more than one server, application modules 310 may reside in separate servers.

Consistent with the first embodiment of the present invention, server 302 also includes another application module referred to as a tour engine 312A for collecting customer request information and grouping the customer requests into tours to be made by the field workers. Tour engine 312A may or may not reside in the same server as application modules 310. Tour engine 312A connects to application modules 310 directly or through a middleware 314 to gather information of customer requests. Such information, the tours, and any updates of the tours received from mobile devices 304 after the customer requests are fulfilled are also stored in database 308. Tour engine 312A also updates application modules 310 with the updates of the tours received from mobile devices 304. The other application modules may then update their respective controlled portions of database 308.

Tour engine 312A may comprise a hardware module in server 302 or may be implemented as a software performing the functions of grouping orders and planning tours, where the software is run in a CPU (central processing unit) in server 302.

Each mobile device 304 may comprise, for example, a PDA having an interface module 316 for communicating with middleware 306 to receive tour information, a database 318 for storing the tour data, and application modules 320 for accessing and updating database 318.

Consistent with a second embodiment of the present invention, tour planning may be achieved through a dedicated tour planning tool external to server 302. A mobile system 300B implementing a method consistent with the second embodiment of the present invention is shown in FIG. 3B. As compared to system 300A in FIG. 3A, system 300B in FIG. 3B further includes a planning tool 320 for planning tours. Also server 300B in FIG. 3B replaces tour engine 312A in server 300A of FIG. 3A with a tour engine 312B. Tour engine 312B gathers information of customer requests from application modules 310 and sends the request information to planning tool 320, which plans tours for the field workers. Planning tool 320 may be a part of server 302 or may be external to server 302. Planning tool 320 provides an interface accessible by tour engine 312B for receiving the information of particular customer requests for planning a tour for a field worker. For example, the interface of planning tool 320 may provide a criteria for determining which customer requests should be fulfilled by a particular field worker. Tour engine 312B gathers the required information and provides the same to the interface of planning tool 320. If planning tool 320 and tour engine 312B reside on the same server, tour engine 312B may directly communicate with the interface of planning tool 320. If planning tool 320 and tour engine 312B reside on different servers, tour engine 312B sends a message containing the required information via a middleware to the interface of planning tool 320 or places a remote function call to transmit the information to planning tool 320.

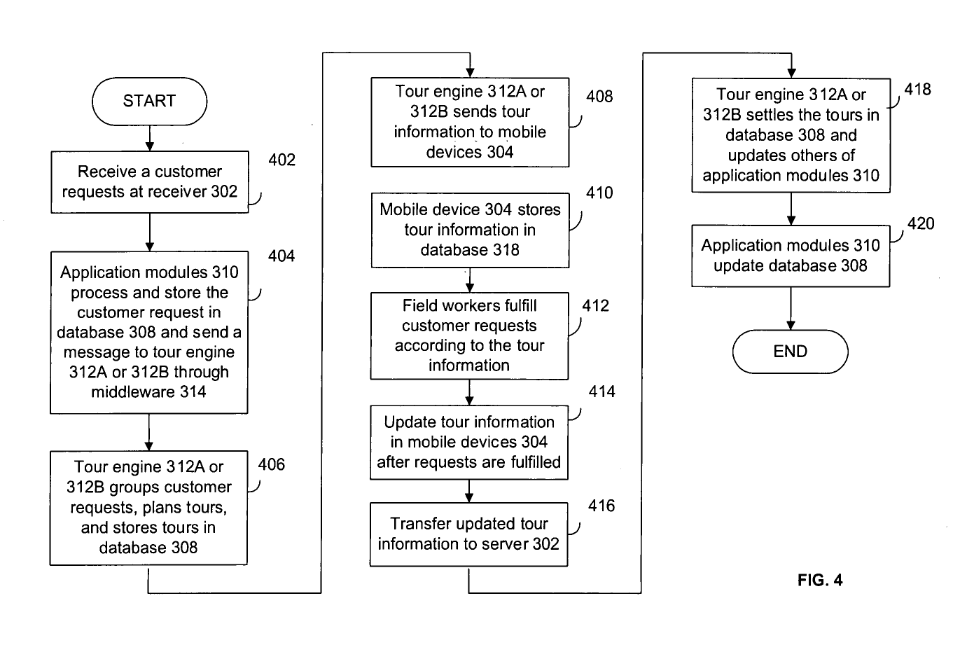

A method consistent with embodiments of the present invention may be carried out by system 300A or 300B. FIG. 4 is a flowchart showing the method consistent with embodiments of the present invention. First, a customer calls in through telephone or the Internet to make a request such as a product or service order (Step 402). Application modules 310 process the customer request and store the customer request information in database 308 (Step 404). In the mean time, application modules 310 send messages to tour engine 312A or 312B through middleware 314 to report the new customer request (Step 404). The customer request information may include, for example, whether it is an order or a service request, the identifier of the product ordered or to be serviced, product price information if it is an order, customer name and address information, method of delivery to use if it is an order, when the product was ordered, the ordered quantity, delivery or service date requested, etc. In some embodiments, server 302 may be connected to one or more application servers (not shown) to obtain information required by mobile device 304. For example, a warehouse server can send delivery information such as whether the products ordered are in stock or whether the order can only be partially fulfilled at the moment, and store such information in database 308.

Then, customer requests are grouped and tours planned for each field worker (Step 406). Consistent with the first embodiment of the present invention, tour engine 312A receives the customer requests and groups them into tours for the field workers. Consistent with the second embodiment of the present invention, planning tool 320 communicates through the interface thereof with tour engine 312B to receive required information for planning tours. Tour engine 312B gathers customer request information and passes the information on to tour planning tool 320 through the interface of planning tool 320. Planning tool 320 plans the tours for the field workers and transfers the tour planning information back to tour engine 312B. Tour engine 312B has an interface for receiving the tour planning information from planning tool 320. Based on the tour planning information, tour engine 312B then generates tours, each tour contains all data required by mobile device 304 related to the customer requests to be handled by the field worker operating mobile device 304. The tours are planned based on suitable criteria such as the addresses where the products are to be delivered or where the services are to be made, the volume of the products, the capacity of each field worker, and the convenience of the field workers, etc. For example, if a delivery person lives on or is familiar with the east side of Manhattan, several or all orders to be delivered on the east side of Manhattan may be grouped together and a trip planned for that delivery person. Similarly, if a service personnel generally services a certain area, all customer requests for services may be grouped together and a tour planned for that service personnel. Other tours are similarly planned for other field workers. The tours are stored in database 308 (Step 406).

In one aspect, the tours are also enriched with configuration data which may be required by mobile devices 304. For example, mobile devices 304 may need pricing information such as unit price because a customer may change his mind upon arrival of the products he ordered. If the price is conditioned on factors such as order quantity, the price schedule must be available on mobile devices 304 for the field workers to adjust the price. Such additional configuration data as the price schedule are generally stored in the database in backend server 302. When tour engine 312A or 312B in server 302 plans the tours for the field workers, tour engine 312A or 312B also determines which additional configuration data are required for the customer requests in each tour and gathers the required additional configuration data into the tours.

Then, the tours are transferred to mobile devices 304 when mobile devices 304 connect to server 302 (Step 408). As a particular example, at the beginning of a work day, the field workers connect their mobile devices 304 to server 302 through middleware 306 or the MI server to receive their respective tour information. The transfer of the tours to mobile devices 304 may be initiated by a message sent from tour engine 312A or 312B through middleware 306 to mobile devices 304 if middleware 306 is used, or by a message sent from tour engine 312A or 312B to the MI server if an MI server is used instead of middleware 306. Alternatively, if neither middleware 306 nor the MI server is used, the tour information may be retrieved by mobile devices 304 when mobile devices 304 directly connect to server 302. Tour engine may for example create a data file which contains the complete tour information and is later picked up by mobile devices 304. After mobile devices 304 receive the tour information, the tour information is stored in database 318 of each mobile device 304 (Step 410). The field workers then make trips to fulfill the customer requests, i.e., delivery personnel make deliveries according to the tour information and service personnel visit customers to service malfunctioning products (Step 412). After the customer requests are fulfilled, the tour information is updated (Step 414). The update of the tour information may include a reflection of an order having been delivered, any adjustments or notes to the customer order information such as price adjustment or that the product is defective, service performed, problem with the product serviced, recommended follow-ups, etc.

When a field worker finishes his tour, he connects his mobile device 304 to server 302, directly or indirectly through middleware 306 or an MI server, to transfer the updated tour information back to server 302 (Step 416). Tour engine 312A or 312B then compares the updated tour information with the tour information stored in database 308 to settle the customer requests in the finished tour (Step 418). At the same time, tour engine 312A or 312B updates application modules 310 with the updated information of the finished tour (Step 418). In one aspect, application modules 310 provide interfaces for receiving the updated information of the finished tour from tour engine 312A or 312B directly. In another aspect, tour engine 312A or 312B sends messages to application modules 310 so that application modules 310 may update the respective portions of database 308. Tour engine 312A or 312B also determines a sequence in which application modules 310 are updated. For example, application modules 310 may include a module for taking and modifying orders, a module for generating delivery instructions and recording delivery status, and a module for generating invoices. Tour engine 312A or 312B may contain logic providing that the module for taking and modifying orders and the module for generating delivery instructions and recording delivery status be updated before the module for generating invoices, because invoices often depend on the orders placed and whether the orders have been delivered. After receiving the updated information of the finished tour, Application modules 310 update their respective portions of data stored in database 308 (Step 420). For example, if an order has been delivered, the data in database 308 are updated to reflect the delivery and the order is closed. If an order was attempted but the recipient could not be reached or the product was found to be defective, the data in database 308 are updated to reflect the attempted delivery or defective product and the order may be included in a tour planned for another business day, for example, a tour planned for the next day. If a customer product has been serviced, the data in database 308 are updated to reflect the identified problem of the product, whether the service solved the problem, and/or recommended follow-ups, etc.

By grouping tours and transferring the data in tours between mobile devices 304 and server 302 rather than individual messages related to individual customer requests, each mobile device 304 only retrieves one package from server 302. As a result, the administration of the data flow between server 302 and mobile devices 304 is much easier. Also, when tour engine 312A or 312B resides in the same server as application modules 310, communications between tour engine 312A or 312B and application modules 310, i.e., the collection and grouping of information of customer requests and the updating of tours, do not require remote function calls (RFC). As a result, the frequency of RFC is greatly lowered and network traffic volume is also reduced.

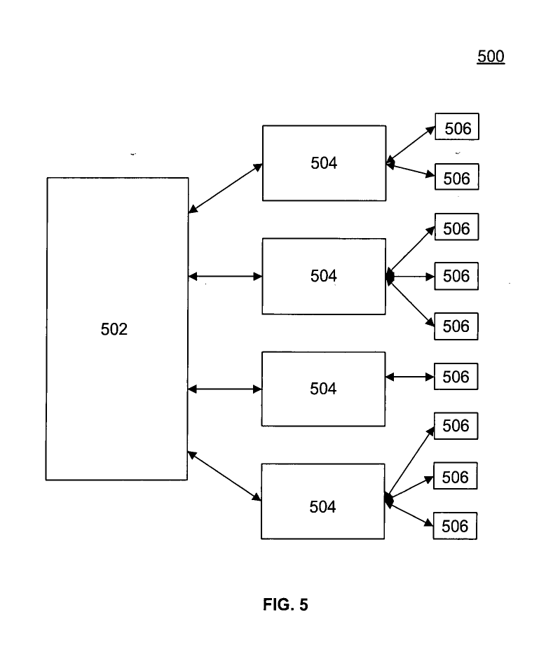

In addition, because server 302 already provides data in the format of tours receivable by mobile devices 304, a mobile system consistent with embodiments of the present invention may be easily expanded by inserting intermediate servers to reduce the work load on server 302. A mobile system 500 with intermediate servers consistent with a third embodiment of the present invention is shown in FIG. 5.

As FIG. 5 shows, mobile system 500 includes a backend server 502, a plurality of local servers 504, and a plurality of mobile devices 506. In one aspect, backend server 502 comprises a server such as server 302 shown in FIG. 3A. In another aspect, backend server 502 includes a server such as server 302 and a planning tool such as planning tool 320 shown in FIG. 3B.

Backend server 502 collects customer request information and plans tours for each field worker. The tours are transferred to the corresponding mobile devices 506. Consistent with the third embodiment of the present invention, tours are transferred through local servers 504 to mobile device 506. Tour information is updated as deliveries are made or attempted or service performed by the corresponding field worker. After a tour is finished, each mobile device 506 connects to backend server 502 through a corresponding local server 504. The requests in the finished tour are updated in backend server 502.

Local servers 504 may be located in different places. For example, a company having offices in Paris, London, and New York may have three local servers 504 each in one of these cities. Before the field workers connect to local servers 504 to download tour information, local servers 504 connect to backend server 502 to receive planned tours for all the field workers in the corresponding cities. Then, all the field workers in one city connect to the corresponding local server 504 to download tour information. After the tours are finished, mobile devices 506 report back to local servers 504 modifications of the customer requests in the tours. Local servers 504 may compare the differences between the data uploaded from mobile devices 506 and the data previously downloaded to mobile devices and, after processing the modifications, transfer the data back to backend server 502.

Because data are provided by server 502 in the format of tours, which are easier to administer than individual messages of orders, it is convenient for companies to add intermediate servers, i.e., local servers 504, to reduce network traffic at backend server 502. This feature may be particularly attractive, for example, for large companies with many delivery personnel. However, a small company covering a small geographic area may find that one backend server is sufficient for all of its business.

In one aspect of the third embodiment, local servers 504 may assist backend server 502 in preparing or finalizing tours by determining one or more aspects of the tour, thereby lessening the burden of tour planning on backend server 502. For example, if additional configuration data such as price schedules are needed by mobile devices 506, the tour engine needs to determine which additional configuration data are required for the customer requests in each tour and access the database in server 502 to gather the required additional configuration data. When many tours have to be processed the determination and the gathering of the configuration data place a big burden on server 502. Consistent with the third embodiment of the present invention, local servers 504 may retrieve the configuration data from backend server 502 and include their own databases for storing such configuration data. When the tour engine plans the tours, the configuration data are not included. Rather, local servers 504 enrich the tours with the configuration data as local servers 504 receive the tour information. When the configuration data are modified in backend server 502, the modifications are transferred to local servers 504.

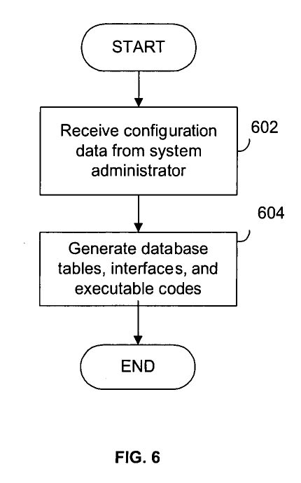

Consistent with embodiments of the present invention, there is also provided a method for generating a software application for implementing the systems and methods described above, as shown in FIG. 6. Any suitable conventional code generation system may be used to generate the software application. Consistent with embodiments of the present invention, a software application may be generated by first receiving configuration data from a system administrator generating the software application (Step 602). The configuration data may include whether system 300A is used instead of system 300B, i.e., whether tour planning tool 320 should be used, what data should be available to the field workers, e.g., whether the name of the call center agent who placed an order should be available to the field workers, whether the mobile devices should have the capabilities of generating invoices, whether only one backend server is used or otherwise local servers are installed, and/or whether a particular sequence is required for updating the application modules such as application modules 310.

Based on the configuration data, tables to be accessed by tour engine 312A or 312B are created in database 308; interfaces are created between middleware 314 and tour engine 312A or 312B and also between tour engine 312B and planning tool 320 if system 300B is used; and codes to be executed by tour engine 312A or 312B are generated (Step 604). For example, if the configuration data indicate that a tour planning tool such as tour planning tool 320 in FIG. 3B is used, then codes executable by tour engine 312A or 312B are generated for retrieving from the tables accessed by the tour engine the information required by planning tool 320. Codes for sending the information to and receiving tour information from planning tool 320, and codes for analyzing and planning tours are also generated. For another example, if local servers are installed, the codes generated include both codes executed at the backend server for gathering customer request information and the settling customer requests and codes executed at the local servers for communicating with the mobile devices and for retrieving the pricing information possibly needed by the mobile devices. Database also need to be created at the local servers. If, however, only one backend server is installed, then all such functions must be performed by the backend server and the codes should be generated accordingly. For yet another example, if the mobile devices have capabilities of generating invoices, codes, interfaces, and database tables should be generated to allow the tour engine to upload an invoice from the PDA to a backend server.

In the above descriptions, customer requests were used as examples of tasks to be performed by a field worker. However, it is to be understood that the systems and methods consistent with embodiments of the present invention are not limited to addressing customer requests. Instead, any need for exchanging data between backend servers and mobile devices may be achieved through a system or method consistent with embodiments of the present invention.

The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Systems and methods consistent with the present invention also include computer-readable media that include program instructions or code for performing various computer-implemented operations based on the methods and processes of the invention. The media and program instructions may be those specially designed and constructed for the purposes of the invention, or they may be of the kind well known and available to those having skill in the computer software arts. Examples of program instructions include, for example, machine code, such as produced by a compiler, and files containing a high level code that can be executed by the computer using an interpreter.

What is claimed is:

1. A method for communicating information of tasks to be performed by field workers between one or more servers and a plurality of mobile devices operated by the field workers, the one or more servers including a tour engine and a plurality of application modules, the method comprising:
originating the tasks to be performed by the field workers at the one or more servers;
planning tours for the field workers at the tour engine by grouping the ones of the tasks to be performed by each of the field workers into a tour; and
transferring information of each of the tours to a corresponding one of the mobile devices.

2. The method of claim 1, further comprising:
updating the information of at least one task by at least one of the mobile devices;
receiving the updated information of the at least one task at the server;
settling the at least one task by comparing the information thereof before and after the updating of the information; and
updating the application modules of the one or more servers, wherein the tour engine determines a sequence in which the application modules are updated.

3. The method of claim 1, wherein transferring information of each of the tours to one of the mobile devices comprises transferring information of each of the tours through one of a plurality of local servers corresponding to the corresponding one of the mobile devices.

4. The method of claim 3, wherein planning the tours comprises partially planning the tours at the local servers by retrieving configuration data, such as a price schedule, from the server and enriching the tours with the configuration data.

5. The method of claim 1, wherein the tasks include delivering customer orders or servicing malfunctioning customer products, wherein originating the tasks comprises receiving requests from customers for product orders or services and generating instructions for delivering the ordered products or the requested services.

6. The method of claim 1, wherein planning the tours comprises enriching the tours with configuration data, such as a price schedule, required by the mobile devices.

7. A method for exchanging information of tasks to be performed by field workers between one or more servers and a plurality of mobile devices operated by the field workers, the tours including a tour engine, the method comprising:
originating the tasks to be performed by the field workers at the one or more servers;
planning tours for the field workers at the tour engine by grouping the ones of the tasks to be performed by each of the field workers into a tour;
transferring information of each of the tours from the tour engine to a corresponding one of the mobile devices;
receiving updates upon performance of the tasks in each tour at the corresponding mobile device;
transferring the updates from the mobile devices to the tour engine; and
settling the tasks in the tours which have been performed.

8. The method of claim 7, wherein planning the tours comprises
sending the information of the tasks to a tour planning tool external to the server in which the tour engine resides; and
receiving planned tours from the tour planning tool.

9. The method of claim 7, wherein transferring information of each of the tours to the corresponding one of the mobile devices comprises transferring information of each of the tours through one of a plurality of local servers corresponding to the corresponding one of the mobile devices.

10. The method of claim 9, wherein planning the tours comprises partially planning the tours at the local servers by retrieving configuration data, such as a price schedule, from the server and enriching the tours with the configuration data.

11. A system for arranging tasks to be performed by field workers, comprising:
one or more servers for originating the tasks, including
a database for storing information of the tasks, and
a tour engine for grouping the tasks to be performed by each of the field workers into a tour.

12. The computer system of claim 11, further comprising:
a plurality of mobile devices, each for receiving information of a corresponding one of the tours and including
an interface module for communicating with the one or more servers, and
a database for storing information of the tasks in the corresponding tour.

13. The computer system of claim 11, further comprising a tour planning tool connected to the tour engine for planning the tours.

14. The computer system of claim 11, further comprising a plurality of local servers for exchanging information of the tours between the servers and the mobile devices.

15. A method for generating a software application for a tour engine in a mobile system, wherein the mobile system includes one or more servers and a plurality of mobile devices, wherein the servers include the tour engine, a plurality of application modules, and a database, and wherein the tour engine gathers customer request information for planning tours for customer requests, the method comprising:
receiving configuration data for generating the software application, the configuration data including at least one of whether the mobile system includes a tour planning tool connected to the tour engine for planning tours, whether the mobile system includes intermediate servers between the server and the mobile devices for assisting in planning and updating the tours, and whether a particular sequence is required for updating the application modules;
creating tables accessed by the tour engine in the database;
creating interfaces between the tour engine and the application modules; and
generating codes to be executed by the tour engine for gathering the customer request information and for planning the tours.

16. The method of claim 15, further comprising, when the mobile system includes the tour planning tool:
creating interfaces between the tour engine and the tour planning tool;
generating codes to be executed by the tour engine for retrieving from the tables accessed by the tour engine information required by the tour planning tool;
generating codes to be executed by the tour engine for sending the information to and receiving tour information from the tour planning tool; and
generating codes for analyzing and planning tours are also generated.

17. The method of claim 15, wherein the configuration data further include the types of information available to the mobile devices, wherein the mobile devices update the tour information, and wherein creating the tables comprises creating tables in the database for storing the information available to the mobile devices and for storing the updated tour information.

18. The method of claim 15, further comprising, when the mobile system includes the intermediate servers:
creating tables in databases in the intermediate servers for storing information of the planned tours and data to be accessed by the mobile devices; and
generating codes executable by the intermediate servers for communicating with the mobile devices and for retrieving data required by the mobile devices from the server.

19. The method of claim 15, wherein the configuration data further include types of functions available to the mobile devices, and wherein generating codes to be executed by the tour engine comprises generating codes for allowing the tour engine to provide the functions available to the mobile devices.

20. The method of claim 19, wherein the functions available to the mobile devices include generating invoices, and wherein:
creating tables in the database comprises creating tables in the database for storing information of invoices generated by the mobile devices;
creating interfaces comprises creating an interface between the tour engine and the mobile devices for allowing uploading invoices generated by the mobile devices into the server; and
generating codes to be executed by the tour engine comprises generating codes for uploading invoices generated by the mobile devices.
